(19) United States
(12) Patent Application Publication
(10) Pub. No.: US 2019/0228482 A1
(43) Pub. Date: Jul. 25, 2019

(54) PROCEDURE AND SYSTEM FOR THE OPTIMIZATION OF THE EXCAVATION PROCESS OF AN UNDERGROUND WORK, FOR THE MINIMIZATION OF THE RISKS INDUCED ON INTERFERED WORKS

(71) Applicant: SWS ENGINEERING S.P.A., Trento-frazione Mattarello (IT)

(72) Inventors: Andrea Danzi, Trento - frazione Mattarello (IT); Gabriele Eccher, Trento - frazione Mattarello (IT)

(73) Assignee: SWS ENGINEERING S.P.A., Trento - frazione Mattarello (IT)

(21) Appl. No.: 16/341,882

(22) PCT Filed: Oct. 16, 2017
(86) PCT No.: PCT/IB2017/056415

§ 371 Date: Apr. 12, 2019

(30) Foreign Application Priority Data
Oct. 14, 2016 (IT) 102016000103634

(51) Int. Cl. G06Q 50/08; G06Q 10/06

(52) U.S. Cl. CPC G06Q 50/08; G06Q 10/0635

(57) ABSTRACT

The system for the optimization of the excavation process of an underground work, for the minimization of the risks induced on interfered works comprises a determination and storage unit for the determination of a plurality of basic parameters needed for the assessment of the phenomena and induced risk scenario in interfered works, starting from a plurality of documents in electronic format, and for the structured storage of the basic parameters inside a database; a definition unit of a plurality of induced risk scenarios which could occur in interfered works, starting from the basic parameters stored on the database; an application unit, for each of the scenarios generated by the definition unit, of predefined geo-mechanical, hydro-geological and structural models, for the quantitative measurement of the factor of risk and/or damage in interfered works; an aggregation unit of each measurement of the factor of risk and/or damage in interfered works, obtained from the application unit for each of the scenarios, to obtain a synthesis of the induced risk on the interfered works.

### TECHNICAL FIELD

The present invention relates to a procedure and a system for the optimization of the excavation process of an underground work, for the minimization of the risks induced on interfered works such as buildings, infrastructures, services or sub-services.

### PRIOR ART

In the context of the design and execution of underground works (of high complexity) it is necessary to evaluate, monitor and manage (at capacity) the effect produced on the surface by the underground voids made using suitable machines.

Excavation can lead to dangerous phenomena, potentially damaging to people and things near the excavations, caused by the redistribution of underground tensions due to the creation of voids made by the excavation machines.

Assessment of the risk allows estimating the effects that will be produced on the surface prior to excavation and is necessary to configure machine parameters to be imposed during excavation and to design any compensation works (design phase).

During actual excavation, the monitoring activity allows measuring the effects produced on the surface (work execution phase) and checking the soundness of the forecasts made during the design phase. After construction work has terminated, risk management continues with the control of potential hazardous phenomena, allowing the maintaining of the value of the underground works and mitigating any events that could occur during the operating phase. This latter phase generally lasts for a short time after the completion of the tunnel building activity.

The occurrence of potential risk phenomena is highly dependent:
on the nature and conformation of the materials characterizing the subsoil;
on the geometry of the layout of the work and hollow;
on the excavation method used and on the excavation operating parameters;
on the nature, state and location of the interfered building, infrastructure, service or sub-service.

The correct assessment of the level of risk induced must necessarily take into account all the listed factors at the same time.

The general procedure involves a first geotechnical calculation which, based on appropriate excavation method efficiency hypotheses, considering the geometry of the layout and of the excavation and the geo-mechanical characteristics, determines the (vertical and horizontal) displacements induced on the springing line of the interfered work, whether this is on the surface or in the ground. The assessment of the risk induced on the interfered work is therefore done by checking its structural response to the field of displacements induced by the excavation of the underground work.

The design engineer has analytical or numerical models (finite element method) both for the geotechnical analysis phase and for the structural analysis phase of the induced risk.

The next risk minimization process, i.e., its reduction to levels deemed acceptable, is an iterative process which first of all affects the parameters of minor economic impact on the total cost of the work, e.g., by varying the operating parameters of a piece of excavation machinery, and should this not suffice, going on to check the effectiveness of gradually more expensive, but more effective jobs. Obviously, the correct assessment should also take into consideration the economic value of the structure which is to be protected, or the cost of its renovation in case of damage, so as to reject jobs whose economic impact exceeds such value.

The procedure must be repeated and specialized for every interfered job. The number of interfered jobs for which an induced risk analysis has to be performed, in the case of building underground railways or urban tunnels, could be in the several hundreds.

It is therefore fairly clear that the procedure, if performed manually, is complex and requires a considerable number of iterations and therefore a high expenditure of resources. The computational cost grows further in the event of wanting to provide a more accurate risk assessment capable of taking into account the uncertainties relating to the geo-mechanical characteristics of the sub-soil or relating to the operating parameters which qualify the soundness of the excavation job.

The traditional risk assessment methods require the engineer to timely gather the parameters required to describe the hazard phenomena and the subsequent predisposition and execution of those calculations which allow understanding the effects produced.

The accurate quantification of the risk level induced on interfered works is generally not possible for both reasons of time and cost. Methods therefore exist which, by means of a series of assumptions, considerably reduce the number of iterations and calculations, obviously to the detriment of the accuracy of the analysis.

One of the proposed methods is split into three phases, as suggested by Mair (“Prediction of ground movements and assessment of risk of building damage due to bored tunneling”, 1996):
1. Preliminary assessment: definition of the field of displacements induced on surface along the entire layout (subsidence basin) for a reduced set (generally 3) of hypothesized efficiencies of the excavation technique and production of a color map. Visual classification of the risk class of each structure lying in the subsidence basin into 5 damage classes according to the maximum failure found in the imprint of the interfered structure. In this phase, no interaction is considered between land and structure.
2. Assessment with simplified structural analysis: for the interfered works only, which fall within damage classes above a preset threshold, a more accurate assessment of the damage class is again made according to analytical criteria which consider the type of structure, the depth and the type of foundation. The interfered works are therefore reclassified in damage classes which take into account the deformation profile they have to undergo. The analyses assume a perfect adherence of the structure to the basin of subsidence induced by the excavation.
3. Detailed assessment: for the interfered works only, which fall within damage classes, assessed in the preceding step, above a preset threshold, supplementary investigations are required aimed at qualifying the structural characteristics of the interfered work. More accurate analyses are therefore carried out by means of analytical or numerical approaches able to take into account earth-structure interaction. If the damage class is reconfirmed precisely analyzed improvement measures are prescribed (to the materials close to the excavation, to the foundations, to the work structure, to the excavation parameters).

The traditional method, due to speed of execution aspects, does not determine the local variation of the representative factor of excavation quality (generally indicated as “lost volume”) along the entire layout. Traditionally, the engineer makes assumptions in relation to such value on the basis of past experiences (direct or bibliographic) and applies two or three possible lost volume scenarios to the entire layout. Alternatively, the engineer performs the process several times introducing subdivisions of the layout into areas of substantially uniform behavior, and therefore assigns various lost volume reference values according to the area. The more the subdivisions, the higher the project cost and the overall inefficiency of the process. The process does not therefore permit a successful management of the degree of uncertainty of the parameters that govern the phenomena, unless cautionary assumptions are introduced. Model refinements only occur locally and therefore in a non-systematic way.

The performance of the process in a manual and non-integrated way is, furthermore, particularly inefficient in case of variations to the input data (e.g., to the geotechnical characterization). The variation of such input parameters is not infrequent inasmuch as the survey campaigns are performed and refined along with design execution. The re-execution of the analyses in a traditional way involves costs in terms of computation and resources more or less identical to the original execution involving heavy design costs.

Finally, it should be observed that the suggested procedure permits the quantification of the risk induced on the interfered works, but it does not permit a relative process of minimization except through the manual iteration of the procedure whenever there is a change in the parameters which govern the risk phenomenon. Risk minimization using traditional methods is therefore a process that requires numerous and inefficient manual iterations.

### DESCRIPTION OF THE INVENTION

The main aim of the present invention is to provide a procedure and a system for the optimization of the excavation process of an underground work, for the minimization of the risks induced on interfered works, which allow, through the use of suitable algorithms applied with automatic calculation, quantifying all the parameters which govern the risk scenario along the entire layout with a level of discretization deemed suitable and without the engineer having to carry out approximations.

Another object of the present invention is to provide a procedure and a system for the optimization of the excavation process of an underground work, for the minimization of the risks induced on interfered works, which allow carrying out locally, in an automatic and integrated way, all the calculation iterations necessary to identify the best excavation configuration/consolidation jobs for minimizing the risk on the interfered work within acceptable technical/economic parameters.

Another object of the present invention is to provide a procedure and a system for the optimization of the excavation process of an underground work, for the minimization of the risks induced on interfered works, which allow applying analyses of the statistic type, able to take into account the degree of indeterminacy which characterizes the calculation parameters. In this sense, the invention is not only able to provide project optimization instruments, but also statistical indications of the distribution of risk of damage on each interfered work, i.e., providing the probability whereby a determinate class of damage is expected.

The innovative system and procedure are characterized by data flows and execution sequences of the automatic type. Human intervention by the operator is required in the result setting and analysis phases. The invention therefore represents an effective system for managing the evolution of the input parameters and permits producing optimized results in short spaces of time. Once the system has been set in fact, the re-execution of the analyses requires minimum human intervention and times tied only to the machine calculation time.

The aforementioned objects are achieved by the present system for the optimization of the excavation process of an underground work, for the minimization of the risks induced on interfered works, according to claim 1.

The aforementioned objects are achieved by the present procedure for the optimization of the excavation process of an underground work, for the minimization of the risks induced on interfered works, according to claim 13.

### BRIEF DESCRIPTION OF THE DRAWINGS

Other characteristics and advantages of the present invention will become more evident from the description of a preferred, but not exclusive, embodiment of a procedure and a system for the optimization of the excavation process of an underground work, for the minimization of the risks induced on interfered works, such as buildings, infrastructures, services or sub-services, illustrated by way of an indicative, but non-limiting example, in the attached drawings in which:

FIG. 1 is a general diagram illustrating the lifespan of an underground work;

FIG. 2 is a general diagram illustrating the procedure and system according to the invention;

FIG. 3 is a diagram illustrating in detail a system determination unit according to the invention which is adapted to determine the basic parameters needed for the assessment of the phenomena and risk scenario induced in interfered works;

FIG. 4 is a general diagram illustrating a system unit according to the invention used for the application of predefined geo-mechanical, hydro-geological and structural models;

FIG. 5 is a general diagram illustrating a system aggregation unit according to the invention used for the representation of the risk synthesis data.

The procedure and system according to the invention permit optimizing the process of excavation of tunnels for the minimization of the risks induced on buildings, infrastructures, services and sub-services, enabling the engineer to operate in a guided manner, on the basis of the automatic processing of objective data coming from the geotechnical context, from the information available on the interfered works and from the mechanical and construction technologies adopted to carry out the underground works.

### EMBODIMENTS OF THE INVENTION

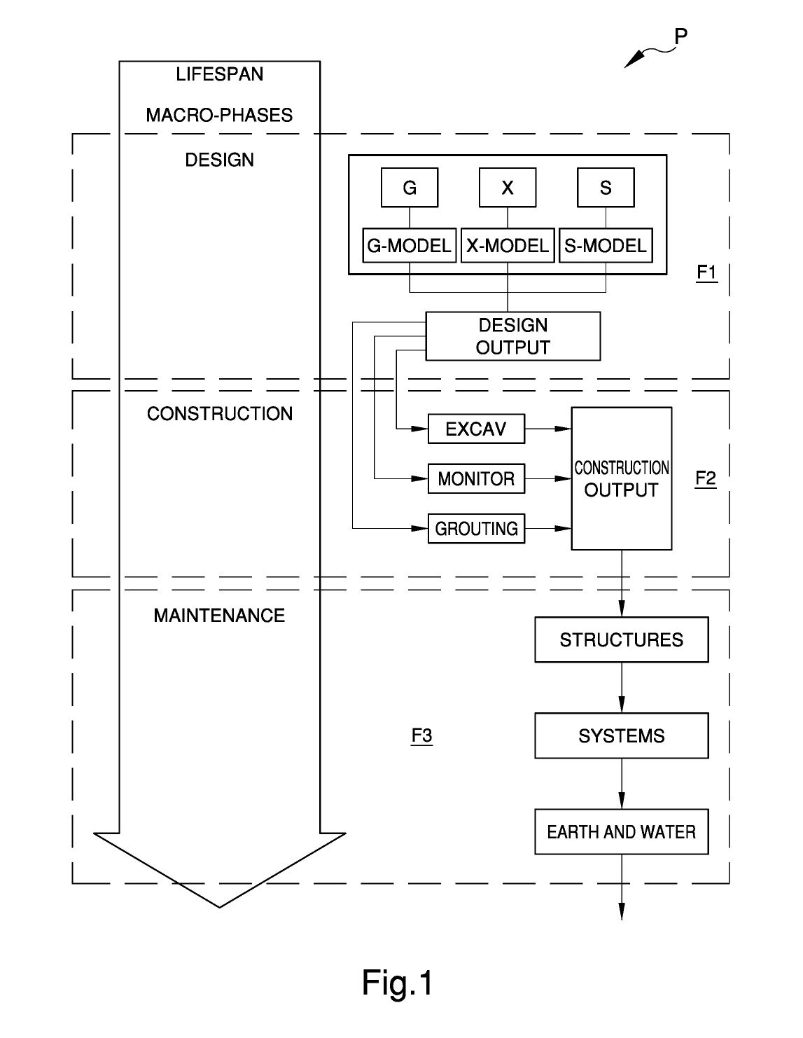

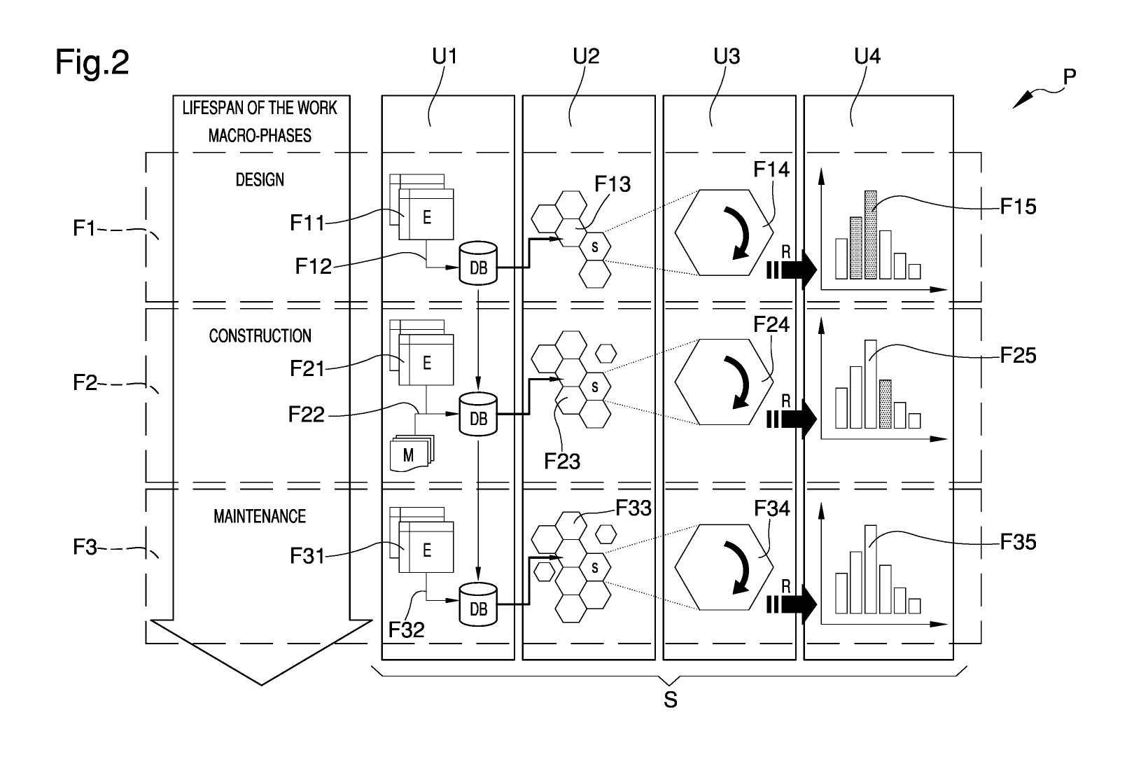

With particular reference to the diagrams in FIG. 1 and FIG. 2, letter P globally indicates a procedure for the optimization of the excavation process of an underground work, for the minimization of the risks induced on interfered works, such as buildings, infrastructures, services or sub-services.

This procedure P divides the analysis of the sources of risk and of their impacts on the interfered works according to the following three time macro-phases that characterize the lifespan of an underground work:
one design phase F1 of an underground work;
one construction phase F2 of the underground work;
one maintenance phase F3 of the underground work.

FIG. 1 schematically illustrates the lifespan of the work.

The design phase F1 goes from the first detection of possible hazardous events to full engineering. In practice, this design phase permits defining the methodology and the envisaged qualitative and functional construction characteristics.

Following the diagram of FIG. 1, in design phase F1 the procedure must make assessments that are based on assumptions deriving mainly from technical standards (Eurocode, classification criteria of the induced damage, etc.) and basic data (topographic, geological, available excavation technologies, excavation operating parameters, type and position of buildings, technical literature) with a certain degree of uncertainty.

The design phase F1 comprises the definition of at least one analysis model selected from: a geotechnical analysis model (G-model) adapted to analyze data in the geotechnical field (G), an excavation efficiency analysis model (X-model) adapted to analyze data relating to the excavation efficiency (X), an analysis model of structural response of the interfered works (S-model) adapted to analyze data relating to the structural response of the interfered works (S).

The construction phase F2 recognizes the results produced by design and physically realizes the interventions according to a limited and well-defined expenditure diagram.

During the construction phase F2, the procedure follows assessments based on design assumptions with the confirmation of objective data which is the result of timely monitoring (Monitor), of data from excavation machines (Excav) and of systems for the improvement of geological conditions (Grouting).

The uncertainty of the data in this phase should decrease and the need emerge to compare the performance requirements indicated in the design phase with those determined at the end of the construction phase. This procedure therefore enables the verification and possible improvement of the implemented predictive models.

The maintenance phase F3 is the phase which allows managing the works once they have come into operation.

During operation, the data are recorded and analyzed in order to maintain the value of the infrastructure over time and to verify its impact in the general context. The performance and safety standard monitoring activities during the operating phase permits tracing risk phenomena, not measurable during construction times, but which must necessarily be taken into account in the design phase.

FIG. 2 illustrates in detail the phases F1, F2, F3 of the procedure P according to the invention as well as the main units U1, U2, U3, U4 which constitute the system S for the automated implementation of such procedure.

Specifically, during the design phase F1, the system S performs the sub-phases F11, F12; F13, F14 and F15 by means of the units U1, U2, U3 and U4.

During the construction phase F2, the system S performs the sub-phases F21, F22; F23, F24 and F25 by means of the units U1, U2, U3 and U4.

During the maintenance phase F3, the system S performs the sub-phases F31, F32; F33, F34 and F35 by means of the units U1, U2, U3 and U4.

In particular, the design phase F1 comprises at least one determination phase F11 of a plurality of basic parameters needed for the assessment of the phenomena and risk scenario induced in the interfered works.

Such determination phase F11 of the basic parameters is made starting from a plurality of documents in electronic format.

In particular, the determination phase F11 comprises one step of collection of a plurality of documents in electronic format.

Specifically, the documents in electronic format can be composed of:
“closed format” documents, for which no libraries are available for direct access to the structured data contained in the document itself (e.g., reports and drawings in pdf format);
“open format” documents, for which libraries are available for direct access to the structured data contained in the document (e.g., calculations in xls format or drawings in dwg format).

The determination phase F11 of the basic parameters also comprises one extraction step E of the text contained in the documents in electronic format.

In particular, such extraction step E involves the recognition of the text contained in the documents in “closed format”.

Conveniently, the determination phase F11 comprises one syntactic analysis (data parsing) step of the extracted text for the identification of the basic parameters.

Furthermore, the determination phase F11 comprises at least one normalization step of the basic parameters obtained.

In particular, such normalization step comprises at least one of: at least one data cleaning step, at least one data transforming step and at least one data aggregating step.

By means of the data cleaning step, more specifically, it is possible to standardize the data according to predefined formats such as, e.g., a same reference system or a same international measuring system.

By using the data transforming step, it is possible to subdivide data that are initially aggregated, e.g., with reference to specific sections of a tunnel to be built.

By means of data aggregating, it is possible to aggregate initially separate data. With reference to the specific solution claimed, the data aggregating step may be optional.

Advantageously, the design phase F1 comprises a structured storage phase F12 of the generated basic parameters within a database DB. In particular, the database DB consists of a geo-referenced database able to associate each property of the various design elements with a precise geotechnical context.

The product of the phase F12 of structured storage consists in the entire set of combinations, geometric-spatial-geo-mechanical-hydro-geological, needed to accurately characterize, both spatially and statistically, the scenarios in which to subsequently assess the subsidence and risk phenomena induced in the interfered works. The support of the database DB is crucial for organizing the information according to the natural development of the work and establishing a sequence of analyses between the elementary components.

In particular, the structured storage phase F12 comprises at least one mapping (collection mapping) step between the determined basic parameters and the tables of the database DB.

Furthermore, the structured storage phase F12 comprises one field mapping step for mapping between the determined basic parameters and the fields of the tables of the database DB.

Finally, the structured storage phase F12 comprises one data loading step of the structured basic parameters S thus obtained on the database DB.

Advantageously, the design phase F1 comprises a definition phase F13 of all possible scenarios of induced risk which could occur in interfered works, determined starting from the structured basic parameters S stored on the database DB.

The product of such definition phase F13 therefore consists of the whole set of geometric, spatial, geo-mechanical and hydro-geological combinations, necessary to characterize, both spatially and statistically, the scenarios in which to assess subsequently subsidence phenomena and of induced risk in the interfered works.

Structured database DB support is crucial to organize information according to the natural development of the work and to establish a sequence of analysis between the elementary components.

Such definition phase F13 provides for the distinction of the elements between analysis dimensions and risk factors. The analysis dimensions are equivalent to keys to identify events, while factors describe the event from a numerical point of view (measurements).

It is crucial to identify the analysis dimension which represents the geometric domain of the work. It must be discretized with a uniform granularity, according to a resolution which allows considering constants within the reference unit as well as the other analysis dimensions attributable to it.

Furthermore, the design phase F1 comprises one application phase F14 for each of the scenarios generated during the definition phase F13, of predefined geo-mechanical, hydro-geological and structural models, for the quantitative measurement of the risk and/or damage factor in the interfered works.

Such application phase F14 of predefined models permits evaluating the parameters which permit a quantitative measurement of the risk and/or damage factor of interfered works using one or more methods and their configurations.

In the event of the obtained risk/damage level not being acceptable, the F14 phase iterates the analysis upon the variation of the design parameters until the minimum risk/damage level is reached obtainable proceeding by cost priority.

The analysis dimensions required for the calculation may have a variable degree of uncertainty as may the underlying theoretical formulas, so the process must be able to be supported by analytical methods, numerical simulations and probabilistic approaches.

The procedure carries out the geo-mechanical, hydro-geological and structural models to generate, starting with the input variables, the parameters which model the quality of the excavation (the lost volume), the subsidence basin, the earth-structure interaction and the structural response of the work to the disturbance introduced by the excavation.

When the analysis domain has heterogeneous parameters, both in dimensional terms and as regards the variability of the statistical properties, the class of computational methods known as the Monte Carlo Method is the most appropriate to obtain estimates through simulations.

The system calculates a series of possible embodiments through N iterations, with the exact weight of probabilities of all possible events, trying to densely explore all the parameter space. The Monte Carlo method permits associating a probability of occurrence of a precise risk of a given entity with each point of the analysis space.

Finally, the design phase F1 comprises an aggregation phase F15 of each measurement of the risk and/or damage factor (R) in interfered works, obtained during the application phase F14 for each of the scenarios, to obtain a synthesis of the risk induced on the interfered works.

This aggregation phase F15 involves structuring the analysis dimensions into aggregation level hierarchies. The levels of analysis represent a view of the risk with respect to a well-defined granularity of the analysis dimensions. With the data from the previous phases and structurally available within the database DB, the procedure involves identifying the parameters which allow allocating the risk factors.

The aggregation phase F15 returns the reprocessing of the simulation data in synthetic formats that are easy to interpret for the human operator. Formats can be both graphic and tabular and are significant for each available aggregation level.

Such reprocessing operations provide effective support to the decision-making phase and constitute traceability elements of the evolution of the residual risk scenario during the proceeding of the work's lifespan.

As shown schematically in FIG. 2, the construction phase F2 comprises the sub-phases F21, F22; F23, F24 and F25, similar to sub-phases F11, F12; F13, F14 and F15 described above for the design phase F1 and implemented by means of the U1, U2, U3 and U4 units of the system S.

In this regard, it is pointed out that the main differences between the analyses carried out during the design phase F1 and the construction phase F2 mainly concern the accuracy of the available data.

In the construction phase F2, in fact, the data comprise data of a general nature through to detailed data specifically applicable to a well-defined portion of the tunnel layout (or of an underground work in general).

The maintenance phase F3 comprises the sub-phases F31, F32; F33, F34 and F35, similar to the sub-phases F11, F12; F13, F14 and F15 described above for the design phase F1 and implemented by means of the U1, U2, U3 and U4 units of the system S.

Specifically, during the work operating phase, information is obtained about the ability of the work to maintain its performance over time. Such information permits ascertaining to what extent the design phase F1 has been exhaustive enough to cover the working lifespan of the work and, consequently, such information can lead to a recalibration of the predictive models used during design.

An example of useful information processed during the maintenance phase F3 could concern the cases wherein subsidence deferred in time occurs, i.e., in a period of time after the construction of the work, or in the event of the vibration or the workloads of the work evolving over time and moving outside the values used in the design phase.

Therefore, in order to evaluate the degree of efficiency of the work, which after all is the purpose of maintenance, the models must be able to transpose and process the data acquired during the operating phase.

The system S adapted to perform the procedure P according to the invention is described in detail below.

Specifically, the system S uses software tools, detailed below, to automate the decomposition of the problem, to analyze the individual components and to recompose solutions.

As schematically illustrated in FIG. 2, the system S comprises one determination and storage unit U1 of the basic parameters needed for the evaluation of the phenomena and of the scenario of risk induced in interfered works.

This unit U1 calculates such basic parameters starting from a plurality of documents in electronic format.

The unit U1 carries out therefore the structured storage of the basic parameters within the database DB.

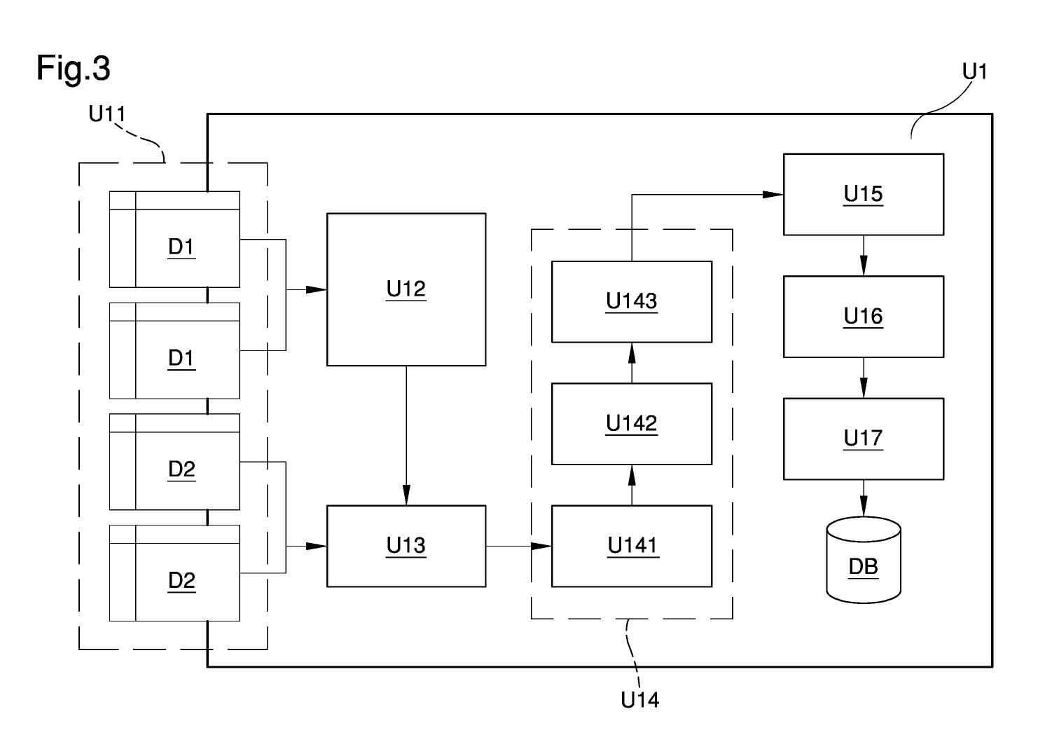

FIG. 3 shows schematically the determination and storage unit U1.

In particular, the determination and storage unit U1 comprises collection means U11 of a plurality of documents D1, D2 in electronic format.

In particular, these documents D1, D2 in electronic format comprise:
“closed format” documents D1, for which no libraries are available for direct access to the structured data contained in the document itself (e.g., reports and drawings in pdf format);
“open format” documents D2, for which libraries are available for direct access to the structured data contained in the document (e.g., calculations in xls format or drawings in dwg format).

The determination and storage unit U1 comprises extraction means U12 adapted to extract the text contained in the documents D1 in electronic format.

In particular, such extraction means U12 comprise means for recognizing the text contained in said documents D1 in “closed format”.

Advantageously, the determination and storage unit U1 comprises syntactic analysis (data parsing) means U13 of the extracted text for the identification of the basic parameters.

Usefully, furthermore, the determination and storage unit U1 comprises normalization means U14 of the basic parameters.

In particular, such normalization means U14 preferably comprise at least one of: data cleaning means U141, data transforming means U142 and data aggregating means U143.

The determination and storage unit U1 also comprises collection mapping means U15 between the basic parameters and the tables of the database DB.

Usefully, the determination and storage unit U1 comprises field mapping means U16 for mapping between the basic parameters and the fields of the tables of the database DB.

Furthermore, the determination and storage unit U1 comprises data loading means U17 of the structured basic parameters S on the database DB.

Advantageously, the system S also comprises one definition unit U2 of a plurality of scenarios of induced risk which could occur in interfered works, starting with said basic parameters stored on said database DB.

Starting with the data recorded in the database DB from the unit U1, the unit U2 carries out the normalization of the information according to the granularity required by specific analysis models activated for each project and according to the geometric analysis dimension (e.g., suitable analysis steps can be defined every 10 m, 20 m, etc.).

Advantageously, furthermore, the system S comprises one application unit U3, for each of the scenarios generated by the definition unit U2, of predefined geo-mechanical, hydro-geological and structural models, for the quantitative measurement of the risk and/or damage factor (R) in interfered works.

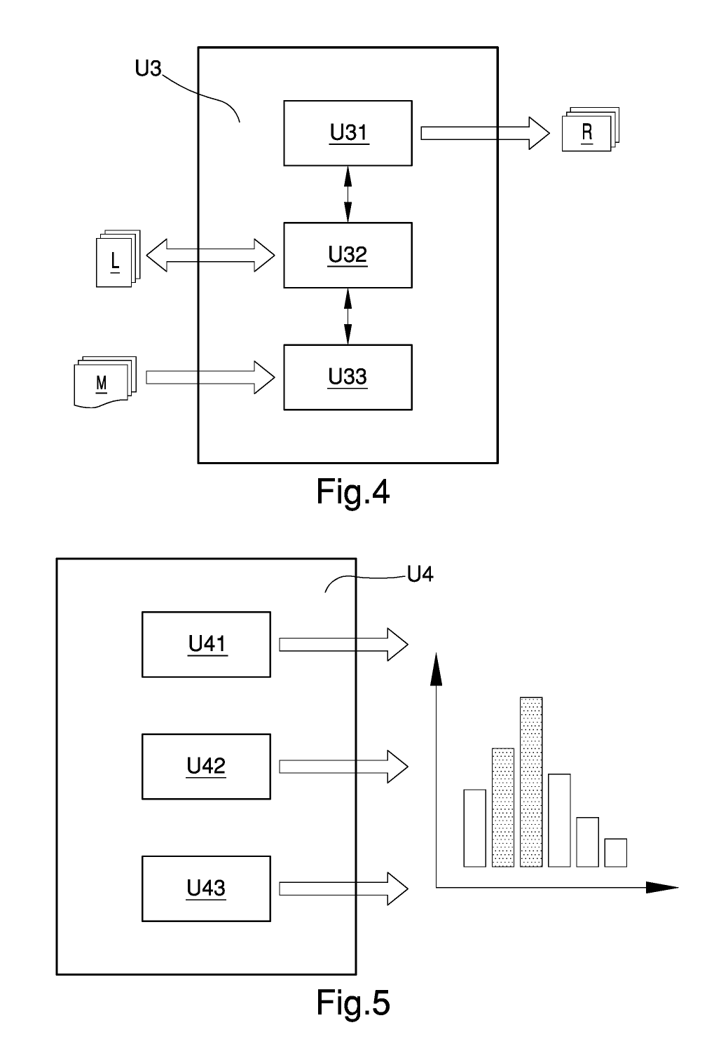

As shown schematically in FIG. 4, the application unit U3 of predefined geo-mechanical and hydro-geological models comprises three different types of functional modules U31, U32 and U33 distinguishable on the basis of the nature of the processing.

In particular, the unit U3 comprises at least one analytical module U31 which implements algorithms, able to achieve the possible embodiment R for solving the problem by means of a well-defined mathematical calculation procedure.

Furthermore, the unit U3 comprises at least one interoperability module U32 adapted to operate with external libraries L, capable of integrating inside the unit U3 methods and algorithms made available in various forms by third parties.

Finally, the unit U3 comprises at least one automatic learning module U33, capable of handling monitoring data M as sources for the representation of new information contents.

Advantageously, finally, the system S comprises at least one aggregation unit U4 for the aggregation of each measurement of the risk and/or damage factor (R) in interfered works, obtained by the application unit U3 for each of the determined scenarios, to obtain a synthesis of the risk induced on the interfered works.

Specifically, as shown schematically in FIG. 5, the aggregation unit U4 comprises at least one module U41 for the representation of the synthesis data along analysis dimensions referable to space (profile and plan of the work).

Furthermore, the aggregation unit U4 comprises at least one module U42 for the representation of synthesis data according to the analysis dimensions needed for the assessment and management of the risks of various nature.

Finally, the aggregation unit U4 comprises at least one module U43 for the interactive analysis of the data organized according to a multi-dimensional model (On-Line Analytical Processing—OLAP).

It has in practice been found that the described invention achieves the intended objects.

In particular, the fact is underlined that the procedure and the system according to the invention permit, through the use of suitable algorithms applied with the automatic calculation, quantifying all the parameters which govern the risk scenario along the entire layout with a level of discretization to be deemed suitable and without the engineer having to perform approximations.

Furthermore, the procedure and the system according to the invention permit performing locally, in an automatic and integrated way, all the calculation iterations needed to identify the optimal excavation configuration/consolidation jobs which minimize the risk on the interfered work within the technical/economic acceptability parameters.

Finally, the procedure and the system according to the invention permit applying analyses of the statistical type able to take into account the degree of indeterminacy which characterizes the calculation parameters. In this sense, the invention is not only able to provide project optimization instruments, but also statistical indications of the distribution of the risk of damage on each interfered work, i.e., providing the probability whereby a determinate class of damage is expected.

1) A system (S) for the optimization of the excavation process of an underground work, for the minimization of the risks induced on interfered works, wherein it comprises:
at least one determination and storage unit (U1) for the determination of a plurality of basic parameters needed for the assessment of the phenomena and induced risk scenario in interfered works, starting from a plurality of documents (D1, D2) in electronic format, and for the structured storage of said basic parameters inside a database (DB);
at least one definition unit (U2) of a plurality of induced risk scenarios which could occur in interfered works, starting from said basic parameters stored on said database (DB);
at least one application unit (U3), for each of said scenarios generated by the definition unit (U2), of predefined geo-mechanical, hydro-geological and structural models, for the quantitative measurement of the factor of risk and/or damage (R) in interfered works;
at least one aggregation unit (U4) of each measurement of the factor of risk and/or damage (R) in interfered works, obtained from said application unit (U3) for each of said scenarios, to obtain a synthesis of the induced risk on said interfered works.

2) System (S) according to claim 1, wherein said determination and storage unit (U1) comprises collection means (U11) of a plurality of documents (D1, D2) in electronic format.

3) System (S) according to claim 2, wherein said documents (D1, D2) in electronic format comprise:
“closed format” documents (D1), for which no libraries are available for direct access to the structured data contained in the document itself;
“open format” documents (D2), for which libraries are available for direct access to the structured data contained in the document.

4) System (S) according to claim 1, wherein said determination and storage unit (U1) for the determination and storage of the basic parameters comprises extraction means (U12) for extracting the text contained in said documents (D1) in electronic format.

5) System (S) according to claim 4, wherein said determination and storage unit (U1) for the determination and storage of the basic parameters comprises syntactic analysis means (U13) of said extracted text for the identification of said plurality of basic parameters.

6) System (S) according to claim 1, wherein said determination and storage unit (U1) comprises normalization means (U14) of said basic parameters.

7) System (S) according to claim 6, wherein said normalization means (U14) comprise at least one of: cleaning means (U141) of the data, processing means (U142) of the data, aggregation means (U143) of the data.

8) System (S) according to claim 1, wherein said determination and structured storage unit (U1) comprises field mapping means (U15) between said basic parameters and the tables of said database (DB).

9) System (S) according to claim 8, wherein said determination and structured storage unit (U1) comprises field mapping means (U16) for mapping between said basic parameters and the fields of the tables of said database (DB).

10) System (S) according to claim 9, wherein said determination and structured storage unit (U1) comprises loading means (U17) of said basic parameters structured on said database (DB).

11) System (S) according to claim 1, wherein said application unit (U3) comprises at least one of: at least one analytical module (U31) for the implementation of algorithms, at least one interoperability module (U32) adapted to operate with external libraries (L), at least one automatic learning module (U33).

12) System (S) according to claim 1, wherein said aggregation unit (U4) comprises at least one of: at least one module (U41) for the representation of synthesis data along analysis dimensions referable to space; at least one module (U42) for the representation of synthesis data according to the analysis dimensions needed for the assessment and management of the risks, at least one module (U43) for the interactive analysis of data organized according to a multi-dimensional model.

13) A procedure (P) for the optimization of the excavation process of an underground work, for the minimization of the risks induced on interfered works, comprising at least one of the following phases:
at least one design phase (F1) of an underground work;
at least one construction phase (F2) of said underground work;
at least one maintenance phase (F3) of said underground work;
wherein at least one of said design, construction and maintenance phases (F1, F2, F3) comprises the following phases:
at least one determination phase (F11, F21, F31) of a plurality of basic parameters needed for the assessment of the phenomena and induced risk scenario in interfered works, starting from a plurality of documents (D1, D2) in electronic format;
at least one structured storage phase (F12, F22, F32) of said basic parameters within a database (DB);
at least one definition phase (F13, F23, F33) of a plurality of induced risk scenarios which could occur in interfered works, determined starting from said basic parameters stored on said database (DB);
at least one application phase (F14, F24, F34) for each of said scenarios generated during said definition phase (F13, F23, F33), of predefined geo-mechanical, hydro-geological and structural models, for the quantitative measurement of the factor of risk and/or damage (R) in interfered works;
at least one aggregation phase (F15, F25, F35) of each measurement of the factor of risk and/or damage (R) in interfered works, obtained from said application phase (F14, F24, F34) for each of said scenarios, to obtain a synthesis of the induced risk on said interfered works.

14) Procedure according to claim 13, wherein said determination phase (F11, F12, F13) comprises at least one step of collection of a plurality of documents (D1, D2) in electronic format.

15) Procedure according to claim 14, wherein said documents (D1, D2) in electronic format comprise:
“closed format” documents (D1), for which no libraries are available for direct access to the structured data contained in the document itself;
“open format” documents (D2), for which libraries are available for direct access to the structured data contained in the document.

16) Procedure according to claim 13, wherein said determination phase (F11, F12, F13) of the basic parameters comprises at least one extraction step of the text contained in said documents (D1, D2) in electronic format.

17) Procedure according to claim 16, wherein said determination phase (F11, F12, F13) of the basic parameters comprises at least one syntactic analysis step of said extracted text for the identification of said plurality of basic parameters.

18) Procedure according to claim 13, wherein said determination phase (F11, F12, F13) comprises at least one normalization step of said basic parameters.

19) Procedure according to claim 18, wherein said normalization step comprise at least one of: at least one cleaning step of the data, at least one processing step of the data and at least one aggregation step of the data.

20) Procedure according to claim 13, wherein said structured storage phase (F12, F22, F32) comprises at least one mapping step between said basic parameters and the tables of said database (DB).

21) Procedure according to claim 20, wherein said structured storage phase (F12, F22, F32) comprises at least one field mapping step for mapping between said basic parameters and the fields of the tables of said database (DB).

22) Procedure according to claim 21, wherein said structured storage phase (F12, F22, F32) comprises one loading step of said basic parameters structured on said database (DB).
